(19) United States
(12) Patent Application Publication
(10) Pub. No.: US 2006/0031449 A1
(43) Pub. Date: Feb. 9, 2006

(54) Selection of management method

(76) Inventors: Mika Hallamaa, Tampere (FI); Mikko Sahinoja, Tampere (FI); Eero Kaappa, Tampere (FI)

Correspondence Address: Hollingsworth & Funk, LLC, Suite 125, 8009 34th Avenue South, Minneapolis, MN, 55425, US

(21) Appl. No.: 10/966,745

(22) Filed: Oct. 15, 2004

Related U.S. Application Data
(60) Provisional application No. 60/585,162, filed on Jul. 1, 2004.

(51) Int. Cl. G06F 15/173

(52) U.S. Cl. 709/223

(57) ABSTRACT

The invention relates to a data processing device comprising: means for defining a management method to be applied in response to a need to arrange delivery of a managed asset for a managed device, and means for applying the defined management method for arranging delivery of the managed asset or a reference to the managed asset for the managed device.

### RELATED APPLICATIONS

This application claims the benefit of the U.S. Provisional Application No. 60/585,162, filed Jul. 1, 2004, the content of which is incorporated by reference in its entirety.

### FIELD OF THE INVENTION

The invention relates to selection of management method in a management system.

### BACKGROUND OF THE INVENTION

As different data processing devices, such as mobile stations, become more complex, the significance of device management becomes more pronounced. Devices require several different settings, such as settings related to Internet access points, and setting them manually by the user is arduous and difficult. To solve this problem, for instance, device management solutions have been developed so that the administrator of a company's information system or a teleoperator can set an appropriate configuration for a device. Device management generally refers to actions by which a person typically not using a device can change the configuration of the device; for instance change the settings used by the device. In addition to device-specific settings, it is also possible to transmit user-specific data, such as user profiles, logos, ringing tones, and menus with which the user can personally modify the settings of the device, or the modification takes place automatically in connection with device management.

One of the device management standards is OMA (Open Mobile Alliance) DM (Device management), which is partly based on the SyncML (Synchronization Markup Language) protocol. For instance, a personal computer (PC) can act as a device management server in a device management protocol and a mobile station as a device management client. In terms of device management, the device management client, possibly on the basis of a triggering message from the device management server, transmits information concerning itself in a session initiation message to the device management server, and the device management server replies by transmitting its own information and a server management command. The device management client replies to this command with status information, after which the server can end the session or transmit more server management commands. If the server transmits more server management commands, the client is to reply to them with status information. The server can always, after receiving status information, end the session or continue it by transmitting more server management commands. Device management can also be implemented by first transmitting queries to the user about what s/he wishes to update, and information on the user's selections is transmitted to the server. Next, the server can in the next packet transmit the updates/commands the user desires.

In current device management systems a management protocol such as the OMA DM protocol is applied, whereby a management command for implementing the desired management task and comprising all necessary management information is directly transmitted to the managed device and executed there. However, a need exists for more versatile management systems.

### BRIEF DESCRIPTION OF THE INVENTION

A method, a management system, data processing devices, computer programs, and data storage mediums are provided, which are characterized by what is stated in the independent claims. Some embodiments of the invention are described in the dependent claims.

According to the invention, management commands may be issued by at least two different management methods. The management method to be applied is defined in response to a need to arrange delivery of a managed asset for a managed device. The defined management method is then applied for arranging the delivery of the managed asset or a reference to the managed asset for the managed device.

The term managed asset is to be understood broadly to refer to any kind information that may be transferred by a management method to a managed device. The term management method refers generally to a management technique for arranging delivery of a managed asset for a managed device or for technique for informing the managed device on a managed asset to be obtained to the managed device. The definition of the management method may thus refer to selection of applied management protocol for arranging the transmission of the managed asset or reference to the managed asset and/or to selection of applied channel or transmission technique for arranging the transmission of the managed asset or reference to the managed asset to the managed device.

The invention makes it possible to apply multiple management methods in a management system such that an appropriate management method for current management context can be chosen.

### BRIEF DESCRIPTION OF THE FIGURES

The invention will now be described in greater detail by means of some embodiments and with reference to the attached drawings, in which

FIG. 1 illustrates some networking scenarios in which the present service management system could be applied;

FIG. 2 illustrates data processing devices according to an embodiment of the invention;

FIG. 3 illustrates a method according to an embodiment of the invention;

FIG. 4 illustrates a method according to an embodiment of the invention;

FIG. 5 illustrates a management tree configuration according to an embodiment of the invention; and

FIG. 6 illustrates a management tree configuration according to an embodiment of the invention.

### DETAILED DESCRIPTION OF THE INVENTION

One embodiment of the invention will be described in the following in a system supporting OMA device management; it should, however, be noted that the invention can be applied to any device management system in which device management objects can also be organized in structures other than tree structures.

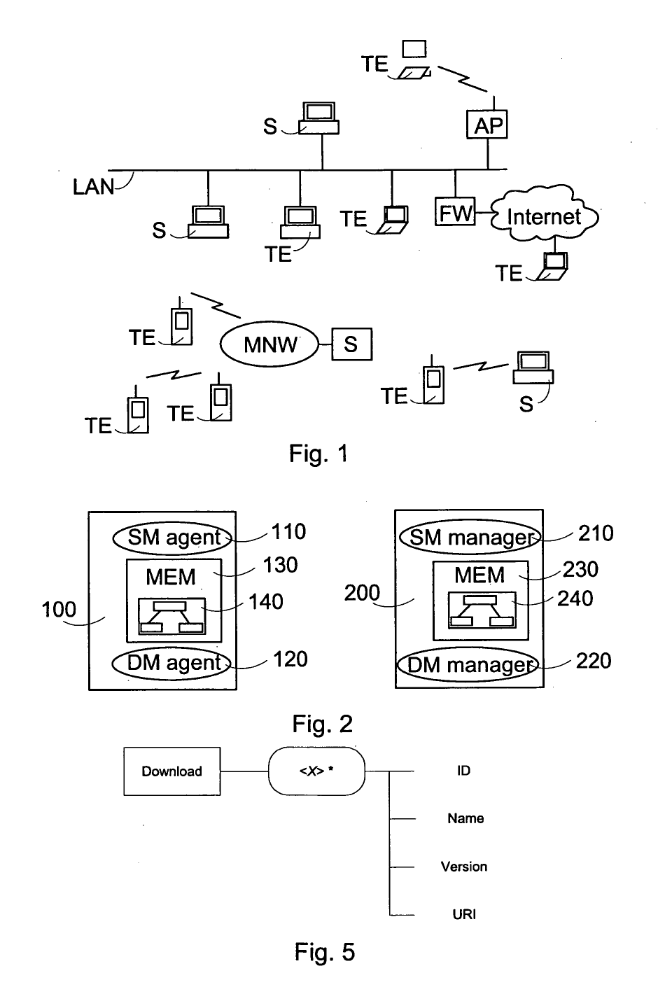

FIG. 1 illustrates a networked system. A network server or a PC typically serves as a server S. A mobile station, PC, laptop computer, or PDA (Personal Digital Assistant) device typically serves as a terminal TE. In the following embodiments, it is assumed that for device management, the terminal TE serves as the device management client and the server S as the device management manager. The server S can manage several clients TE.

FIG. 1 shows two examples, in the first of which the clients TE and the management servers S are connected to a local area network LAN. A client TE connected to the network LAN comprises a functionality, such as a network card and software controlling data transmission, for communicating with the devices in the network LAN. The local area network LAN can be any kind of local area network and the TE can also be connected to the server S through the Internet, typically using a firewall FW. The terminal TE can also be connected to the local area network LAN wirelessly through an access point AP.

In the second example, the client TE communicates with the server S through a mobile network MNW. A terminal TE connected to the network MNW comprises a mobile station functionality for communicating wirelessly with the network MNW. There may also be other networks, such as a local area network LAN, between the mobile network MNW and the server S. The mobile network MNW can be any known wireless network, for instance a network supporting GSM services, a network supporting GPRS (General Packet Radio Service) services, a third-generation mobile network, such as a network according to the network specifications of 3GPP (3^{rd} Generation Partnership Project), a wireless local area network WLAN, a private network, or a combination of several networks. One important service of the transport layer in many mobile networks is a WAP which comprises a WSP (Wireless Session Protocol) layer with which a transport service can be provided for a device management application layer in a client TE and a server S. The system then comprises at least one WAP gateway and possibly one or more WAP proxies. Other protocols can also be used for transporting device management messages. Another important transport technology that may be utilized is an HTTP (Hyper Text Transfer Protocol). The lower-layer transport techniques can be circuit- or packet-switched in accordance with the properties of an underlying mobile network MNW. In addition to the earlier examples, many other device management configurations are also possible, such as a management connection between terminals TE or a direct management connection between the terminal TE and server S by using a wireless or a wired connection without any other network elements.

FIG. 2 illustrates functional entities of a data processing device 100 functioning as a managed client device in view of service management and a data processing device 200 functioning as a server in view of service management. For instance, referring to FIG. 1, the terminal TE could be the client device 100 and the server S could be the server device 200. The data processing device 100 comprises a service management agent 110 (which may also be referred to as a service management client) for monitoring and/or performing service management level operations. The service management level operations may be performed by executing service management commands originally defined by a service management (SM) manager 210. The SM manager (which may also be referred to as an SM server) 210 defines SM commands and may, in one embodiment, map SM commands to device management (DM) commands on the basis of mapping instructions which may be stored in a memory 230.

In the present embodiment, management method selection is applied in a service management system utilizing OMA device management capabilities. These OMA device management capabilities may be specifically used for service management level purposes such that service management level commands are specified (between the managing device 200 and the managed device 100) by device management commands. The data processing device 100 serving as an OMA device management client comprises a DM (client) agent 120 that takes care of functions related to the device management session in the client. The DM (client) agent 120 may execute device management commands from a device management manager 220 (which may also be referred to as a device management server) for management objects in a management tree 140, deliver the DM commands to the SM agent 110, and/or perform the mapping between received DM commands and SM commands. The data processing device 200 serving as a device management server comprises a DM manager 220 managing the OMA DM management session which, in one embodiment, may perform mapping of SM commands from SM manager 210 to DM commands. A suitable transport protocol, such as HTTP, may be used for DM level communication.

Items managed in a device management client device are arranged as device management objects. The device management objects are entities that can be managed by management commands to the device management client. A device management object can for instance be a number or a large entity, such as a background image or a screensaver. At least some of the device management objects can be standardized entirely or partly. In OMA device management, the device management objects are arranged in a management tree 140. The management tree 140 is stored in the memory 130 in the data processing device 100, and information and/or device description thereof (240) can also be stored in the memory 230 of the data processing device 200. The management tree 140 is made up of nodes and defines at least one device management object formed of one or more nodes or at least one parameter of a node. The node can be an individual parameter, a sub-tree or a data collection.

The management structure comprising managed objects can be any structure containing manageable items, without being limited to the device management trees of OMA device management. Service management typically involves management of a particular software application providing the service, thus the service management may include application management and the term command refers to any management command or primitive on the basis of which the management action can be effected.

It is to be noted that the entities of FIG. 2 are only exemplary and a single entity or more than two entities may implement the functions of agents 110 and 120, for instance.

Mapping instructions for arranging mapping between service management commands and device management commands are stored in the data processing device 200. The SM manager 210 may be configured to establish a device management command or primitive on the basis of a service management command and the mapping instructions 250.

In an embodiment, mapping instructions for defining service management commands for received device management commands are stored in the memory 130 of the device 100 comprising the SM agent 110 functionality. This embodiment enables the conversion of received DM commands into required SM commands (which are to be understood broadly to include also primitives or SM operations in some other form), which may then be carried out by the SM agent 110. Alternatively an SM command is defined in the client device 100 on the basis of or in response to the execution of one or more DM commands.

It is to be noted that the mapping instructions may be directly implemented in the control logic of the SM manager 210 (or another entity performing the mapping between SM and DM commands, for instance the DM manager 220), whereby no separate file for mapping instructions 250 needs to be stored but the mapping instructions may be stored within the program code controlling the processor of the device (200), for instance.

The (client) data processing device 100 may further comprise a separate management tree module for modifying the management tree (140) on the basis of the DM commands from the DM agent (120) and the SM commands from the SM agent (110). The (client) data processing device 100 may also comprise information on dependencies between manageable objects.

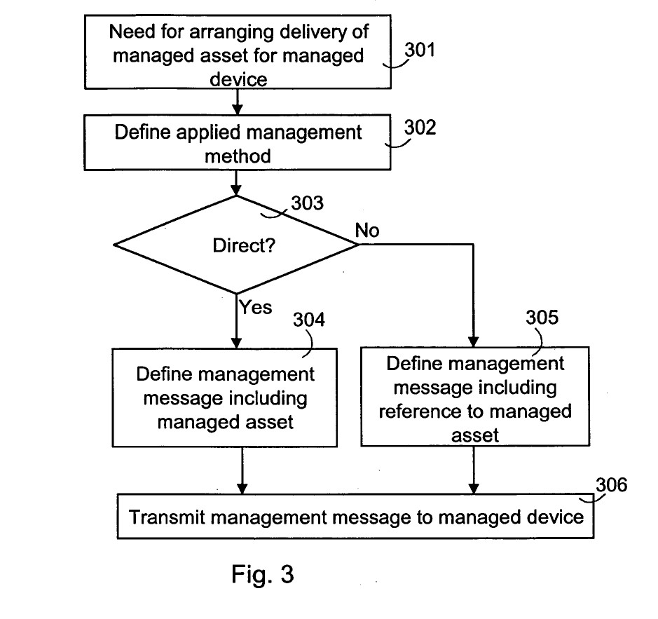

The data processing devices 100, 200 further comprise a transceiver for arranging data transfer, and a processing unit comprising one or more processors. Computer program codes executed in the processing unit may be used for causing the data processing devices 100, 200 to implement the inventive means relating to usage of multiple management methods, some embodiments of which being illustrated later in association with FIGS. 3, 4, 5, and 6. A chip unit or some other kind of module for controlling the data processing device 100 and/or 200 may, in one embodiment, cause the device to perform the inventive functions. The module may form part of the device and could be removable, i.e. it can be inserted into another unit or device. Computer program codes can be received via a network and/or be stored in memory means, for instance on a disk, a CD-ROM disk or other external memory means, where from they can be loaded into the memory of the data processing devices 100, 200. The computer program can also be loaded through a network by using a TCP/IP protocol stack, for instance. Hardware solutions or a combination of hardware and software solutions may also be used to implement the inventive functions. It is to be noted that information relating to (referred) managed assets may be stored in internal memory or external memory (for instance a removable memory card or an IC card) of the data processing device 200, or in an external storage. It is to be noted that it is not necessary to support both service management (SM) and device management (DM) features in the devices 100, 200.

According to an aspect of the present application, at least two different management methods are available for the device functioning as the management server (200). The management server (200) may be configured to select an appropriate management method or a combination of management methods for managing the client device (100), more precisely for arranging delivery of managed assets to the first device.

FIG. 3 illustrates a method according to an embodiment, wherein the method may be implemented in the management server device 200. In step 301 there is a need for arranging delivery of a managed asset to a managed device (100), i.e. there is a need to manage the device (100). This need may arise based on an upper layer command, or client device (100) request, for instance. A management method to be applied is defined in step 302. This definition may be carried out by many ways, as will be illustrated later in more specific embodiments. If the management method to be applied is direct, a management message including the managed asset (which may be configuration data, for instance) is defined 304. Alternatively, if the management method is indirect, a management message including a reference to a managed asset to be delivered to the managed device 100 is defined 305. The message defined in step 304 or 305 also comprises an appropriate management command, for instance in the case of direct management an “ADD” command addressed to the node under which the managed asset is to be stored, and the asset may locate in the data container section of the management command. After steps 304 or 305, the management message is transmitted to the managed device 100. The features illustrated in FIG. 3 may be repeated for each managed asset to be transmitted or it is possible to apply the selected management method for multiple managed assets.

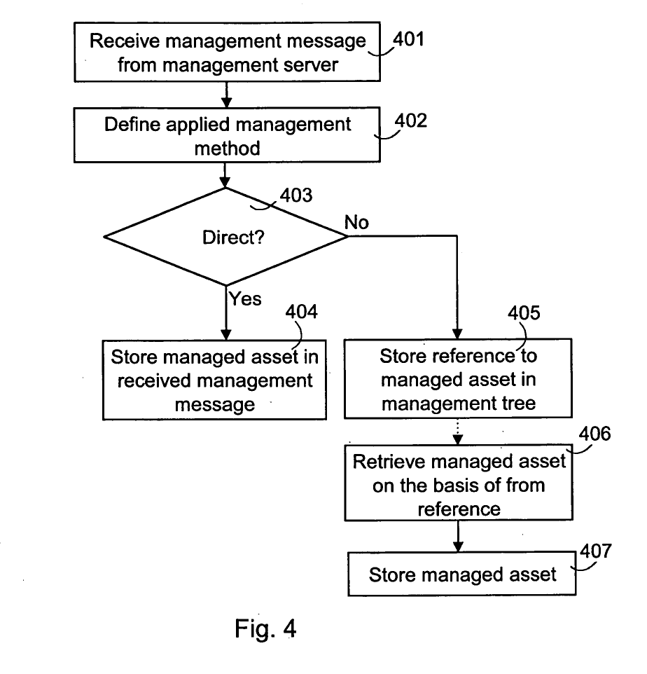

FIG. 4 illustrates a method according to an embodiment, wherein the method can be implemented in the managed (client) device 100. In step 401 the device receives the management message from the management server (200). The management method to be applied is defined 402. If the management method to be applied is direct, the management command is carried out and the asset included in the received management message may be stored 404. Thus the received management message comprises a command of a direct management method. Alternatively, if the management method to be applied is indirect, i.e. the received management message comprises a command of an indirect management method; the reference to the managed asset is stored 405 in the management tree 140. The managed asset may be retrieved 406 on the basis of the reference immediately or later on the basis of an internal or an external trigger for carrying out the referred managed asset. For instance, step 406 may be entered automatically and/or the received management command including the reference to the managed asset may include an indication for retrieval on the basis of which step 406 is entered. Further, in the case of immediate retrieval, it is not necessary to store the reference, i.e. step 405 could be omitted. After the information relating to the managed asset is retrieved (for instance one or more device management commands), the referred asset may be stored 407.

It is to be noted that instead of FIG. 4, steps 402 and 403 are not always necessary, but the received management command may be executed and the execution of the command automatically leads either to step 404 or step 405.

The definition of the management method to be applied in step 302 may be based on the currently available management methods, properties of the managed asset to be delivered, on the basis of the properties of the manageable device and/or some other decision criterion.

In one embodiment a first managed asset is delivered to the managed device (100) by direct delivery, i.e. by transmitting the command by a (DM and/or SM) management protocol from the managing device (200). The direct delivery is especially suitable for managed assets requiring high security level since the secure management session is used for delivery. For instance, the OMA DM security features may thus be used in direct delivery.

Indirect delivery may be applied for a second managed asset, whereby only a direct or indirect reference to the asset is first delivered to the managed device. This reference may be transmitted by a management protocol. The managed device may then retrieve the managed asset, for instance an automatically installing software update package, on the basis of the reference. The reference may be a URI to the location from which the managed asset is to be retrieved. The managed asset may be retrieved by some data transmission technology, for instance HTTP or FTP download. Thus a device management/service management session is not required for the retrieval (although the system could be configured to use device management/service management functions in step 406). The indirect delivery is especially suitable for delivering large managed assets and thus the amount of data transferred by management commands may be limited. The indirect delivery further enables that not all managed assets need to be stored in the managing device (200) but some managed assets may instead be stored elsewhere, for instance in a WWW (World Wide Web) server.

According to an embodiment, at least two different management channels are applied. The term “channel” herein refers generally to a particular delivery method for arranging the delivery of the management command to the managed device.

In one embodiment in step 302 one of the available transport alternatives is selected. For instance, a first transport channel enabling real-time transport and a second transport channel enabling non-real-time but very secure transport are available for transferring the managed asset to the managed device. The device 200 may be configured select the applied transport channel on the basis of the properties of the managed asset to be delivered. The device 200 may be configured to check one or more predetermined properties of the managed asset to be carried out and select a transport associated with the property in predetermined selection rules. For instance, if the managed asset is an installation file, the second transport providing more reliable transfer is selected.

In one embodiment the definition in step 302 is based on user input. This means that a user of the managing device 200 may define the management method to be applied.

It is to be noted that a managed asset may involve a plurality of sub-components, or a plurality of managed assets needs to be issued/transmitted in order to carry out a required management action in/for the managed client device 100. In this case the above illustrated different management methods may be used in combination. Thus the managing device (200) may define that multiple management method are utilized for carrying out a management task involving a plurality of managed assets. For instance, for managed asset A direct delivery is used, whereas for managed asset B (relating to the same management task as the asset A) indirect delivery is used. It is possible to select, for each managed asset or a sub-component, the applied management method as illustrated above in connection with FIGS. 3 and 4, in which case multiple management methods may be utilized in combination, possibly consecutively or in parallel. For instance, the managing device 200, possibly the SM manager 210, specifies that a base service component is delivered directly whereas plug-in modules of the service are to be delivered by the indirect delivery.

Further, it is even possible to apply more than one management method for a delivery of a single managed asset or a sub-component.

In one embodiment, referring to FIG. 5, the management tree 140 is provided with a “Download” node for storing references to the managed assets, i.e. for arranging the indirect delivery. In FIG. 5 one exemplary entry including an identifier, a name, a version and a URI for such referred managed asset is illustrated. Thus the received management command may comprise this information which is in step 405 stored to the management tree 140 as a sub-node under the “Download” node. It is to be noted that the information in the entry, i.e. the sub-node of the “Download” node, is only an example. For instance, if the URI or some other type of identifier identifying the location of the asset does not indicate the appropriate retrieval method for retrieving the object, a specific “Type” information attribute indicating the retrieval method such as “HTTP” could be stored in an entry for a referred managed asset.

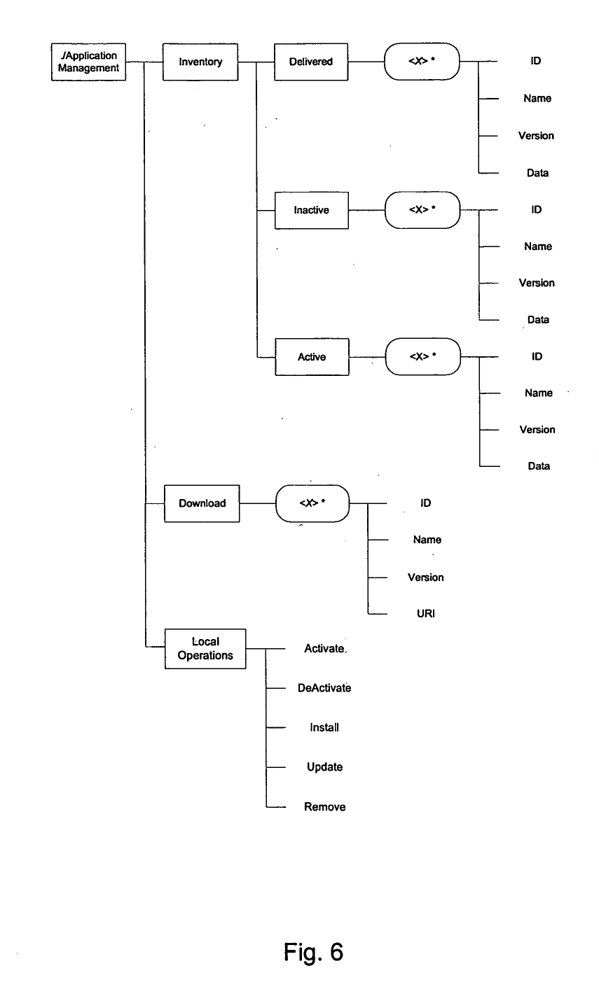

As already mentioned, the agent (110 or 120) may retrieve the reference from the URI data stored in this node in response to an external or internal trigger, for instance an input from the user or an installation command from the managing device (200) or a command from a third device, for instance the device to which the URI refers to. The downloading of the asset may be activated in the embodiment of FIG. 5 by sending an execution command for an entry of the asset in the “Download” node. The asset can then be retrieved from the URI and stored elsewhere in the management tree 140. There after above illustrated further features may be applied for the managed asset, for instance a software component in the received information may be installed. This could be done by issuing an execution command to “Install” node illustrated in one further management tree configuration in FIG. 6.

It is possible to utilize at least some of the features of the OMA DM specifications in the present system; for a more detailed description of the OMA device management protocol and other commands, for instance, reference is made to the OMA specification “SyncML Device Management Protocol”, version 1.1.2, 12 Jun. 2003, 41 pages, and the OMA specification “SyncML Representation Protocol Device Management Usage”, version 1.1.2, 12 Jun. 2003, 39 pages. In chapter 6.5, the latter specification defines the different protocol operation elements with which the DM manager 220 and/or the SM agent 110 may define the DM commands to the management tree 140 of the managed client device 100. The OMA DM specification “SyncML Device Management Tree and Description”, version 1.1.2, chapter 9.3.4 describes the current management tree related features. In one scenario, conventional OMA DM procedures are applied between the DM manager 220 and the DM agent 120 for configuration management, i.e. for setting appropriate configuration parameters and the present SM procedures are applied for management of services, typically for management of entire applications or at least application portions, covering for instance installation and updates instead of merely setting appropriate settings.

The SM level entities (SM manager 210 and the SM client 110) may be configured to use at least some of the DM layer services, in the present embodiment the OMA DM services, specified in the OMA DM specifications. Besides the above-illustrated device management features, OMA DM security and session management features may be utilized, for instance.

The above-illustrated features may be applied for service management (SM) and/or device management (DM). In one embodiment in step 302 and in step 402 it is defined whether SM or DM management is applied. Since these management techniques are by their nature very different (SM is especially suitable for high level application and service management, whereas DM is very suitable for configurations settings management), this embodiment enables the selection of suitable management protocol. At least part of the already mentioned criteria may be applied when selecting between SM and DM in step 302. It is to be noted that the checking steps 303 and 403 are not necessary in this embodiment; for client device 100 it is enough that it defines whether SM or DM features are to be applied. It is to be noted that if SM level management is selected, the DM level services may be utilized for arranging the delivery of the SM level managed asset, as will be illustrated later.

In the following, service management features according to an embodiment are further illustrated, referring also to FIG. 2. These service management features may also be used for arranging delivery of management assets.

In one embodiment, the service management manager 210 defines one or more DM commands on the basis of a SM level command (when SM has been selected as the management method) and forwards them to the DM manager 220 which communicates the DM command(s) using a DM protocol to the DM agent 120 in the managed device 100. In this embodiment the DM functions are used to serve the transmission of SM level commands. Thus, in protocol layer view, the DM layer is underneath the SM layer and uses transport services of an underlying transport protocol layer such as the HTTP. Alternatively the DM manager entity 120 may be configured to perform the mapping 402 between the SM and DM commands.

In one embodiment, the DM client 120 receives the DM message and defines a corresponding SM command for the received DM command. The DM client 120 may then forward the defined SM command or may indicate the required SM command to the service management agent 110. Thus the DM agent 120 may be configured to notify the SM agent 110 on the basis of the one or more received device management commands. The SM agent 110 may then carry out the one or more service management commands on the basis of the notification from the DM agent 120. The DM agent 120 may notice on the basis of the target node or an area in the management tree 140 identified in the received DM command that an SM command needs to be defined.

The DM agent 120 may perform the DM command to a node controlled by the SM agent 110 in the DM tree 140. In an embodiment the SM agent 110 is configured to detect a modification to the management tree 140 due to execution of one or more device management commands. The SM agent is thus triggered to initiate an action to carry out a SM level management action, see for instance the use of “Local Operations” node illustrated later. For instance, the SM agent 110 may be configured to follow one or more nodes of the management tree 140 and detect an execution command to such node, thereby identifying the required SM command.

The SM agent 110 may be configured to further modify the management tree 140 in accordance with the derived service management command. In a further embodiment, the received device management command comprises a plurality of sub-tasks and is mapped by the SM agent 110 into a plurality of service management commands.

In an alternative embodiment the DM agent 120 merely delivers the received DM command to the SM agent 110. The SM agent 110 may then define a corresponding SM command for the received DM command and carry out the required action.

The management system is configured to support a number of management commands in order to deliver and manage services, for instance native applications and/or application components. In one embodiment the following SM commands or primitives are supported: service and/or application inventory, delivery, installation, activation/deactivation (not necessary for all services/applications), update, and removal. These commands may be utilized in the above illustrated method features, but it is to be noted that the scope of the invention is not limited to any particular commands, and any forthcoming command types may also be used. In one embodiment the inventory of existing manageable items is made before any other SM management commands are defined by the SM manager 210.

In an embodiment, the service management system employs deployment components for controlling some of manageable items controlling a service in the client device 100. A deployment component is an abstraction model dedicated especially for SM level management functions, and it represents a group of manageable items of an application. This embodiment provides flexibility for service management operations, and closely-related manageable items may be gathered as a single deployment component.

For instance, a deployment component in the management tree 140 can be an executable, a library, a setting, a resource, a UI element, a certificate, or a license. A deployment component may be associated with a predetermined number of states. A current state of the deployment component may be changed by atomic state transfer primitives. The deployment component may be an independent file, an .SIS file, a .CAB file, a .JAR file, or a .ZIP file, for instance. At least some of the following metadata attributes can be determined in a management tree 140 for a deployment component, and also in a delivery package from the DM server 220 comprising one or more deployment components: Version, identifier, name (Displayable name for the component), type (If not part of the component content), size, and location. The deployment components may be bundled into a delivery package between the SM server 210 and the SM agent 110, optimised for delivery purposes (for instance compressing or DRM (Digital Rights Management)). The SM system keeps a record of deployment components and their status, in the present embodiment by the management tree 140. The service management SM commands from the SM server 210 to the SM agent 110 are thus addressed to one or more deployment components.

In one embodiment, at least one node is stored in the management tree 140 for a deployment component. These deployment component nodes may be modified using SM commands which may be defined (by the SM agent 110 or the DM agent 120) on the basis of received DM level commands. As already mentioned above, the service management agent 110 may be configured to maintain information on deployment components in the management tree 140.

At least some of the above illustrated management method definition features are in one embodiment applied for arranging delivery of service management deployment components. In one embodiment at least part of these features are implemented in the SM level by SM agent 110 and the SM manager 120. For instance, the SM level command for indirect delivery of a deployment component is mapped to a DM level ADD command to the “Download” node, the command comprising the reference information of the deployment component as illustrated in the sub-node of FIG. 6. This DM command is then transmitted by the DM manager 220 to the DM agent 120 by a DM session. By the execution of the received DM command, the DM agent 120 adds this new sub-node to the management tree. On the basis of this DM level message execution (or a specific notification from the DM agent 120), the SM agent 110 may then identify that a SM level indirect delivery for a deployment component represented by this new node is required. Immediately or upon a later trigger, the SM agent 110 may then initiate the retrieval of the deployment component from the URI obtained from the sub-node. In another example (a DM level) execution command is defined and addressed to the “Download” node such that the URI and possibly also other identifiers are specified as parameters of the execution command. Depending on the system implementation, this execution command could cause the immediate downloading of the managed asset or storage of the parameters, for instance under the “Download” node or another node for pending deliveries of managed assets.

According to an embodiment, the deployment component is associated in the management tree 140 with a state describing the current status of the deployment component. Thus, state information can be easily obtained for a deployment component from the same management tree 140. In a further embodiment, the management tree 140 comprises a node for at least some of the possible states such that the deployment component is stored under a node described the current state. For instance, suitable states could be “Active”, “Inactive”, and “Delivered”. This embodiment is illustrated in the exemplary management tree in FIG. 6, wherein deployment components may be stored under an appropriate state node. If a deployment component is associated with the state “Delivered” (in the example of FIG. 6 stored under the “Delivered” node), the deployment component has been delivered to the client device 100 (for instance by steps 404 or 406 and 407) but has not been installed. After installation, the component would have the state “Inactive”.

Further, the service management system may provide means for making an inventory of the existing deployment components. In one embodiment the inventory is carried out by the SM agent 110 and the results of the inventory, i.e. information indicating the existing deployment components in the device 100, are returned to the DM client 120 which forwards them by a DM message to the DM manager 120. The DM manager 120 forwards information on the existing deployment components to the SM manager 210. The inventory may be carried out by traversing through the management tree 140, searching for deployment components. In another embodiment, the management tree 140 comprises a specific inventory node for arranging an inventory of the deployment components. In one possible implementation scenario, nodes for each possible state are sub-nodes of an inventory node, as illustrated in FIG. 6. It is to be noted that the states may also be implemented in other ways, for instance under a node other than the “Inventory” node, or state information may be stored in a deployment component node.

In one embodiment the management tree 140 comprises a node “Local Operations” for arranging (local) operations for the management tree 140.

As illustrated in the example of FIG. 6, a sub-node may be stored for each local operation in the management tree 140. In response to an execution command to an operation sub-node, an associated local operation is carried out and, as a result, one or more other nodes in the management tree 140 are modified. In one embodiment, the DM command is defined in the server device 200 such that the DM agent 120 issues an execution command to a local operation sub-node. On the basis of this execution command, the SM agent 110 is configured to carry out the actual (SM level) local operation associated with the local operation sub-node and modify the management tree 140 appropriately.

For instance, a sub-node is arranged for an activation operation, (“Activate”). In response to execution command to this sub-node, at least one node comprising a deployment component or another manageable object is set to active state. Referring to the state embodiment also illustrated in FIG. 6, a deployment component under the “Inactive” node would then be moved under the “Active” node.

Other exemplary local operations shown in FIG. 6 are “Deactivate” for deactivating an object or a component, “Install” for installing an object or a component, “Update” for updating an object or a component, and “Remove” for removing an object or a component.

It is to be noted that, instead of the example in FIG. 6, operations in the management tree 140 may be carried out without local operations and the “Local operations” node in the management tree. For instance, state transactions (between states “Delivered”, “Inactive”, and “Active”) may be carried out by direct “ADD” and “DELETE” commands to the respective nodes. For more details on a service management system in which the present features related to application of multiple management methods could be applied, and how local operations may be arranged in a management system, reference is made to co-pending U.S. patent application Ser. No. ______ (Attorney Docket No. 2041385US; KOLS.144PA) entitled “Device Management System” filed on Oct. 15, 2004, and U.S. patent application Ser. No. ______ (Attorney Docket No. 2041433US; KOLS.142PA) entitled “Arranging Management Operations in Management System” also filed on Oct. 15, 2004, the content of both such co-pending applications being incorporated herein by reference in their entireties.

In the following, some service management uses cases are illustrated.
Corporate IM (IT Management) installs a new business application.
Corporate IM updates an existing business application.
Corporate IM analyzes a virus definition file in a manageable device.
Service provider updates an existing plug-in for a browser.
Service provider updates a messaging application UI (User Interface).
Service provider controls game service: According to the terms of a service agreement, the service provider de-activates a service and the service is activated only after the user pays the bill.
Corporate IM reinstalls a faulty application.
Service provider installs a new codec for a media player.

It is to be noted that instead of the above-illustrated corporate IM and service provider entities, other kinds of administrative entities may be in control of the management server device 200 and manage the client device 100 by the present SM and/or DM features. For instance, network operators or manufacturers could also be such administrative entities.

It should be noted that the embodiments described above could also be applied in any combination thereof. It is apparent to a person skilled in the art that as technology advances, the basic idea of the invention can be implemented in many different ways. The invention and its embodiments are thus not restricted to the examples described above but can vary within the scope of the claims.

1. A data processing device for a management system, the data processing device comprising:
means for defining a management method to be applied in response to a need to arrange delivery of a managed asset for a managed device, and
means for applying the defined management method for arranging delivery of the managed asset or a reference to the managed asset for the managed device.

2. The data processing device according to claim 1, wherein the data processing device comprises means for applying a direct management method in which a management command message comprising the managed asset is transmitted by a management protocol to the managed device.

3. The data processing device according to claim 1, wherein the data processing device comprises means for applying an indirect management method in which the reference to the managed asset is transmitted in a management command message to the managed device.

4. The data processing device according to claim 3, wherein the data processing device is configured to define a management command addressed to a pre-determined node for references in a management structure comprising manageable objects in the managed device, the command comprising at least the reference to the managed asset.

5. The data processing device according to claim 3, wherein the data processing device is configured to define a URI of the managed asset in the management message.

6. The data processing device according to claim 1, wherein the data processing device is configured to transmit a management command message comprising the managed asset or a reference to the managed asset on the basis of the OMA DM management technology.

7. The data processing device according to claim 1, wherein the data processing device comprises a service management manager for issuing service management commands and the managed asset is a service management level deployment component.

8. The data processing device according to claim 7, wherein the data processing device comprises means for defining one or more device management commands on the basis of predetermined mapping instructions and a service management command for arranging delivery of the deployment component or a reference to the deployment component.

9. The data processing device according to claim 1, wherein the data processing device is configured to define that a first management method is applied for delivering a first managed asset relating to a management task and a second management method is applied for delivering a reference to a second managed asset relating to the management task to the first device.

10. A method for arranging management of a first device by a second device, the method comprising:
applying a first management method for delivering a first managed asset relating to a management task to the first device, and
applying a second management method for delivering a reference to a second managed asset relating to the management task to the first device.

11. A data processing device for a management system, the data processing device comprising:
means for storing a managed asset in a received management message if the received management message comprises a command of a direct management method,
means for storing a reference in a received management message to a managed asset if the received management message comprises a command of an indirect management method, and
means for retrieving the managed asset on the basis of the reference.

12. The data processing device according to claim 11, wherein the data processing device comprises means for defining a management method to be applied for a received management message.

13. The data processing device according to claim 11, wherein the data processing device is configured to store the reference to a pre-determined node for references in a management structure comprising manageable objects in the managed device.

14. The data processing device according to claim 11, wherein the data processing device is configured to retrieve the managed asset on the basis of the reference in response to a command from a management server.

15. The data processing device according to claim 11, wherein the data processing device comprises an OMA device management (DM) management technology compliant agent for receiving the management command and executing the management command.

16. The data processing device according to claim 11, wherein the data processing device comprises:
a service management client for monitoring and/or performing service management level operations and the managed asset is a service management level deployment component.

17. A management system for managing a first device by a second device, wherein
the second device is configured to apply a first management method for arranging delivery of a first managed asset relating to a management task to the first device, and
the second device is configured to apply a second management method for arranging delivery of a reference to a second managed asset relating to the management task to the first device.

18. A computer program downloadable into the memory of a data processing device for a service management system, the computer program comprising a computer program code which, when executed in the processor of the data processing device, causes the data processing device to:
define a management method to be applied in response to a need to arrange delivery of a managed asset for a managed device,
apply the defined management method for arranging delivery of the managed asset or a reference to the managed asset for the managed device.

19. A data storage medium for storing a computer program downloadable into the memory of a data processing device for a service management system, the computer program comprising a computer program code which, when executed in the processor of the data processing device, causes the data processing device to:
define a management method to be applied in response to a need to arrange delivery of a managed asset for a managed device,
apply the defined management method for arranging delivery of the managed asset or a reference to the managed asset for the managed device.

20. A computer program downloadable into the memory of a data processing device for a service management system, the computer program comprising a computer program code which, when executed in the processor of the data processing device, causes the data processing device to:
store a managed asset in a received management message if the received management message comprises a command of a direct management method,
store a reference in a received management message to a managed asset if the received management message comprises a command of an indirect management method, and
retrieve the managed asset on the basis of the reference.

21. A data storage medium for storing a computer program downloadable into the memory of a data processing device for a service management system, the computer program comprising a computer program code which, when executed in the processor of the data processing device, causes the data processing device to:
store a managed asset in a received management message if the received management message comprises a command of a direct management method,
store a reference in a received management message to a managed asset if the received management message comprises a command of an indirect management method, and
retrieve the managed asset on the basis of the reference.
